(19) United States
(12) Patent Application Publication
(10) Pub. No.: US 2004/0243998 A1
(43) Pub. Date: Dec. 2, 2004

(54) Method and apparatus for restoring an information handling system to a previous software state

(75) Inventors: Mark A. Collins, Austin, TX (US); Darryl J. Konopka, Austin, TX (US); Robert Hunter Robertson, Cedar Park, TX (US); Rick G. Malone, Leander, TX (US); William Hoi Ching Wong, Round Rock, TX (US)

Correspondence Address: HAYNES AND BOONE, LLP, 901 MAIN STREET, SUITE 3100, DALLAS, TX, 75202, US

(73) Assignee: Dell Products L.P., Round Rock, TX (US)

(21) Appl. No.: 10/445,652

(22) Filed: May 27, 2003

(51) Int. Cl. G06F 9/445

(52) U.S. Cl. 717/178

(57) ABSTRACT

A method and apparatus are provided for restoring the software image of a customer information handling system (IHS) to the same software image it had when it left the factory or other software installation facility. The customer IHS enters a re-imaging mode wherein it requests a software download server to recreate the software image originally shipped with that particular IHS. Once the replacement software image is created, the customer IHS downloads the replacement software image to the media drive of the customer IHS.

### BACKGROUND

The disclosures herein relate generally to information handling systems and more particularly to methodology and apparatus for restoring information handling systems to a previous software state.

As the value and use of information continue to increase, individuals and businesses seek additional ways to process and store information. One option available to users is information handling systems. An information handling system (IHS) generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

IHS's typically include a media drive or other permanent storage on which a factory download software image is stored. The factory download image includes the operating system, applications, hardware and software drivers as ordered by the customer. When the IHS with its included download image is received by the customer, the customer activates the IHS to install the operating system, drivers and applications on the media drive. After this installation process is complete, the IHS is ready for use by the customer.

Unfortunately, it is possible that the installed operating system, applications and drivers can become corrupted over time for a variety of reasons. For example, the IHS may be subjected to a virus. It is also possible that customer-installed applications other than those contained in the original download image may cause such corruption. Another cause of media drive corruption is when the user accidentally deletes a file which is necessary for the IHS to properly function. Corruption of the media drive can become so severe than the IHS will not operate correctly. In that case, it may be necessary to erase the media drive and start the software installation process over again.

When the media drive becomes corrupted in the above described manner, the customer often places a phone call to the manufacturer's technical support department. If technical support confirms that the customer's media drive is indeed corrupted, the original factory download image must somehow be resupplied to the customer. One way to achieve this is to burn another copy of the original factory download image onto a replacement hard drive. A third party technical maintenance person is then dispatched to the customer's site to replace the corrupted media drive with the replacement media drive. This approach, while effective, is very time consuming and expensive.

Another solution to the problem of restoring a software image to an IHS with a corrupted media drive is described and claimed in U.S. Pat. No. 6,298,443 entitled “Method and System for Supplying a Custom Software Image to a Computer System”, naming Thomas Colligan, et al. as inventor. This patent is incorporated herein by reference in its entirety, and is assigned to the assignee of the prevent invention. Colligan et al. disclose burning a custom-programmed compact disk (CD) with the original factory download software image. The new CD is then sent to the customer by mail or express transit service. The customer then uses the new CD to restore the IHS to the software state that the IHS exhibited at the time the IHS left the factory. Unfortunately, however, time is lost while the new CD is being transported to the customer.

Therefore, what is needed is a method and apparatus for more quickly restoring an IHS media drive to a prior software state when the media drive becomes corrupted.

### SUMMARY

Accordingly, in one embodiment, a method of returning a customer information handling system (IHS) to a prior software state is disclosed. The method includes the customer IHS transmitting an image restore request to a remote download software server. The method also includes the remote download software server receiving the image restore request and in response building a replacement software image from software stored on the remote download software server. The remote download software server transmits the replacement software image to the particular customer IHS that requested that its image be restored. The replacement software image is then stored on a media drive of the customer IHS for installation thereon.

In another embodiment, a software server information handling system (IHS) is disclosed which includes a network port for receiving an image restore request from a customer IHS. The software server IHS includes a download server, coupled to the network port, for storing a plurality of software programs. The download server builds a replacement software image for the customer IHS in response to the image restore request received from the customer IHS. The customer IHS then downloads the replacement software image thus returning the customer IHS to the software state it exhibited when it was manufactured. In one embodiment, the replacement software image is unique to the customer IHS.

A principal advantage of the embodiments disclosed herein is the substantial decrease in the time needed to replace the software image off an IHS whose software has become corrupted.

### BRIEF DESCRIPTION OF THE DRAWINGS

FIG. 1 is a block diagram of an information handling system for which software image restoration is desired.

FIG. 2 is a representation of the information handling system of FIG. 1 which is networked to a factory or fulfillment facility to which a software image restoration request can be directed.

FIG. 3 is a flowchart which depicts the disclosed process for restoring the software image of an information handling system.

### DETAILED DESCRIPTION

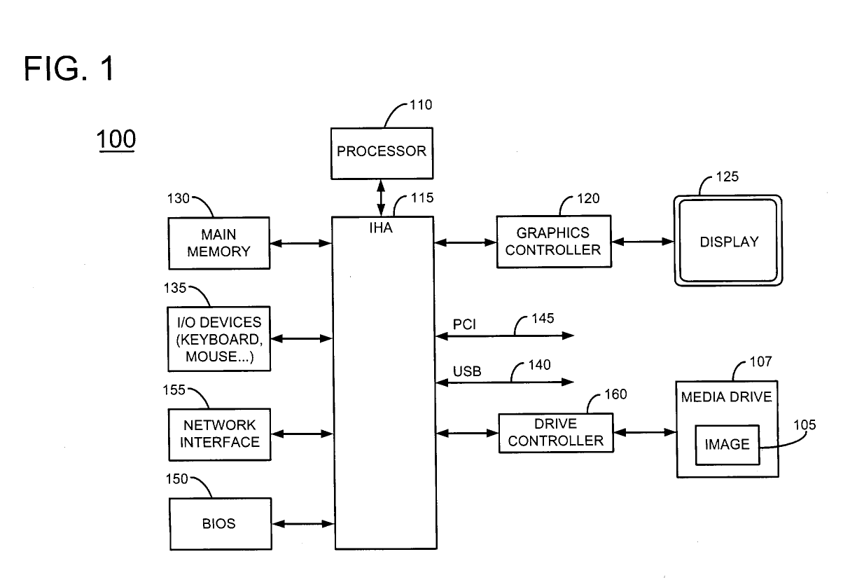

FIG. 1 is a block diagram of an information handling system 100 on which a software image 105 is to be restored. It is assumed that the software installed on the IHS has become corrupted and is in need of reinstallation. The corrupted software may include the operating system, drivers, applications as well as other software stored on media drive 107.

For purposes of this disclosure, an information handling system (IHS) may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Information handling system (IHS) 100 includes a processor 110 such as an Intel Pentium series processor or one of many other processors currently available. An Intel Hub Architecture (IHA) chipset 115 provides IHS system 100 with glue-logic that connects processor 110 to other components of IHS 100. Chipset 115 carries out graphics/memory controller hub functions and I/O functions. More specifically, chipset 115 acts as a host controller which communicates with a graphics controller 120 coupled thereto. Graphics controller 120 is coupled to a display 125. Chipset 115 also acts as a controller for main memory 130 which is coupled thereto. Chipset 115 further acts as an I/O controller hub (ICH) which performs I/O functions. Input devices 135 such as a mouse, keyboard, and tablet, are also coupled to chipset 115. A universal serial bus (USB) 140 is coupled to chipset 115 to facilitate the connection of peripheral devices to IHS 100. An expansion bus 145, such as a Peripheral Component Interconnect (PCI) bus, is coupled to chipset 115 as shown. Expansion bus 145 includes one or more expansion slots (not shown) for receiving expansion cards which provide IHS 100 with additional functionality. System basic input-output system (BIOS) 150 is coupled to chipset 115 as shown. BIOS 150 is stored in nonvolatile memory such as CMOS or FLASH memory. A network interface controller (NIC) 155 is coupled to chipset 115 to facilitate connection of system 100 to other information handling systems.

A media drive controller 160 is coupled to chipset 115 so that devices such as media drive 107 can be connected to chipset 115 and processor 110. Devices that can be coupled to media controller 160 include CD-ROM drives, DVD drives, hard disk drives and other fixed or removable media drives. When IHS 100 leaves the factory, the IHS includes software such as the operating system, drivers and applications which are stored in media drive 107 in the form of software image 105. Over time it is possible that the operating system, drivers, applications or other factory installed software become corrupted. This can be caused by user error, viruses or the installation of incompatible software. For purposes of this disclosure, it is assumed that the software on media drive 107 has become corrupted and that it is desired to restore the original software image 105 which was stored in media drive 107 prior to its departure from the factory.

If the particular IHS was built to order, then the particular combination of software installed on the IHS may be unique to that machine. In one embodiment, each IHS manufactured by the factory has a unique identification code or identifier such as a service tag number or express service code assigned thereto. In this manner each IHS manufactured can be uniquely identified. When an IHS is built in a build to order factory, each IHS's unique identification code is stored along with a listing of the particular hardware and software which uniquely form this particular IHS. More specifically, the unique code and associated IHS hardware and software configuration information are stored in the IHS and at the factory or other repository. When the IHS was originally manufactured, the particular operating system, applications and drivers selected were tested together for compatibility and were stored together as image 107 in IHS 100. It is this software image 107 which is to now be restored.

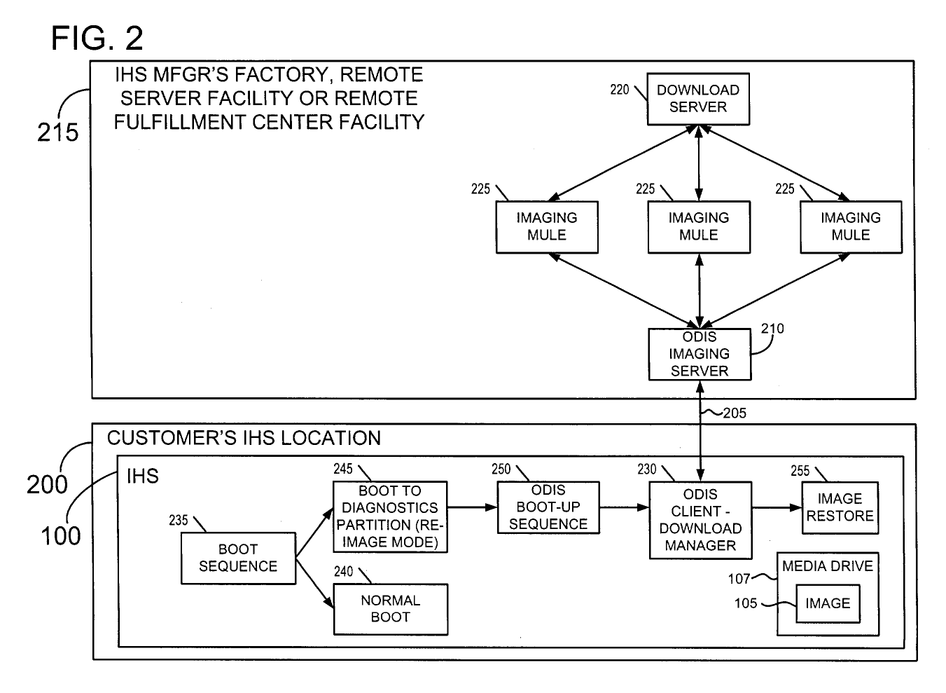

FIG. 2 illustrates an apparatus and process for restoring a software image to a customer information handling system, IHS 100, which is situated at a customer or user's location 200. Customer IHS 100 is coupled by a network connection 205 to an on-demand imaging server (ODIS) 210. Network connection 205 may be a local area network connection, a wide area network connection, an Internet connection or other connection coupling IHS 100 to imaging server 210. Imaging server 210 is located at the IHS manufacturer's factory or other remote fulfillment center or server facility 215. Facility 215 includes a remote download software server 220 which stores copies of all operating system versions, drivers, application software and BIOS versions used by the factory to manufacture and store software images on IHS's. Download server 220 also includes the unique service tag and express service code numbers and the corresponding hardware and software configuration information corresponding to the IHS's associated with those unique numbers. In actual practice, download server 220 can include multiple servers and storage subsystems. Download server 220 is coupled to multiple imaging mule computers 225. As described later in more detail, imaging mules 225 implement a software transport mechanism to facilitate reconstruction of a particular software image which corresponds to the unique identification code associated with the particular IHS for which a reconstructed software image is to be recreated or otherwise formed. Imaging mules 225 are coupled to ODIS imaging server 210 which sends the reconstructed software image to ODIS client software 230 which resides in IHS 100. In actual practice, the ODIS client software 230 is stored in the media drive 107 of the IHS.

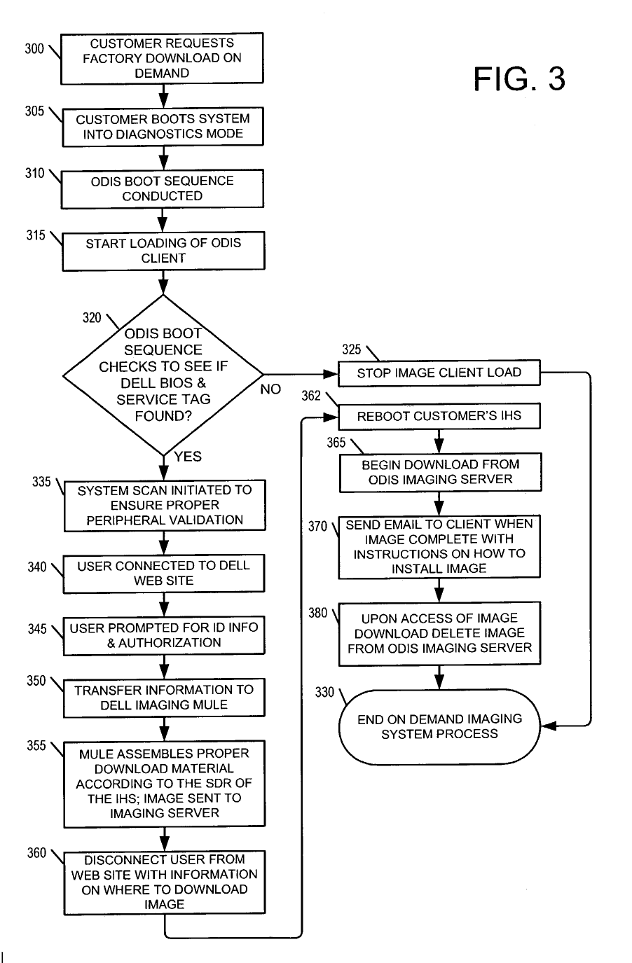

IHS 100 is shown in FIG. 2 principally as functional blocks which describe steps that occur to initiate a request for a software image to remote server facility 215 and to achieve retrieval of the requested software image therefrom. When IHS 100 is turned on, the boot sequence begins as per block 235. If the user selects a normal boot as per block 240 then the operating system loads and the IHS becomes operational and ready to execute application software as directed by the user. However, if the user wants to request a new software image to replace factory installed software now believed to be corrupted, then the user selects the option of booting to a diagnostics partition as per block 245. In response, an on demand image boot-up sequence commences as per block 250 and ODIS client software loads as per block 230. More detail regarding these operations will be provided later in the discussion of the flow chart of FIG. 3.

The ODIS client software 230 is a download manager software client which logs onto ODIS imaging server 210 to request the download of the particular software image corresponding to the unique identification number associated with the particular IHS. Download server 220 authenticates the request from the particular IHS and gathers the software needed to form the requested software image. One of imaging mules 225 actually assembles the requested image from the software stored on download server 220. When that mule 225 completes the task of forming the custom replacement software image, it sends the software image to ODIS imaging server 210 for transport to the ODIS client software 230 running on IHS 100. The ODIS download manager client 230 in cooperation with ODIS imaging server 210 manage the download of the requested software image to IHS 100. The software image thus recreated and transported is also referred to as a replacement software image. ODIS client 230 receives the requested image and an image restore operation is performed as per block 255. The format of the resultant replacement software image can be one of many choices available for software image creation, for example the “Drive Image” format available from Power Quest or the “Ghost” format available from Symantec. Upon download the replacement software mage is transferred to media drive 107 where it is stored as image 105. The process disclosed above returns the software in the IHS to an earlier software state, namely the software state which existed at the time the IHS shipped from the factory or the time at which software was installed on the IHS by a facility in the supply chain.

FIG. 3 is a flow chart depicting the disclosed software image restoration process. A determination is initially made that the software on a particular IHS 100 has somehow become corrupted. In other words, a change has occurred in the originally installed factory software. This change has so impaired system operation that it is now desirable to reinstall software on the IHS from a copy of the software image originally placed on the media drive at the factory. To start the process of obtaining a replacement copy of this particular IHS's software image, the customer or user of the IHS enters a replacement request into the IHS as per block 300. This replacement request is a request for a copy of the factory download software image corresponding to the particular IHS as originally installed by the factory. When the replacement request is made, a diagnostics mode, also referred to as a “re-image mode”, is entered by IHS 100 as per block 305. One way to select the diagnostics or re-image mode is to boot the IHS to a diagnostics partition on media drive 107. An on-demand imaging server (ODIS) boot up sequence then commences in which IHS 100 boots up in a DOS-mode as per block 310. ODIS client software 230, a download manager, commences loading as per block 315. The ODIS boot sequence checks to see if the IHS manufacturer's BIOS is installed in the particular IHS as per decision block 320. The boot sequence also checks to see if a unique identifier such as the service tag or express service code is stored in the IHS. If it is found that the IHS does not contain the IHS manufacturer's BIOS or the unique identifier, then the loading of the ODIS download manager client is halted as per block 325 and the on-demand imaging system process terminates as per block 330.

However if the IHS manufacturer's BIOS and unique identifier are found in the IHS as per decision block 320, then the ODIS client download manager continues to load and a system scan of the IHS is conducted to ensure proper validation of peripherals as per block 335. The IHS is then connected to a web-site on ODIS imaging server 210 via network 205 as per block 340. In one embodiment the user is prompted by a web page on the web site for identification information as per block 345. This identification information is used to determine if the user has authority to request a software image. This can be achieved by submission of previously authorized username with corresponding password. Another method of determining if an activity on a web site is authorized is described and claimed in U.S. Pat. No. 6,038,597 entitled “Method and Apparatus for Providing and Accessing Data at an Internet Site”, naming Amy Van Wyngarden. as inventor. This patent is incorporated herein by reference in its entirety, and is assigned to the assignee of the prevent invention.

If it is determined that the request for image download is authorized, then the unique identification information (e.g. service tag) associated with the particular IHS 100 is sent to download server 220 along with a request for a reassembly of the particular software image stored on the media drive of that IHS when it left the factory. A system descriptor record (SDR) for that particular IHS's service tag is determined and accessed by the download server. The SDR is essentially a list of the hardware and software that are included in the IHS when it ships from the factory. The unique operating system, drivers, applications and other software specified in the SDR associated with that IHS are sent to one of imaging mule computers 225 as per block 350. Imaging mule 225 consolidates or assembles together the software indicated by the SDR to form a software image as per block 355. When the software image is complete the software image is transmitted to ODIS imaging server 210 as per block 355. The software image now stored on imaging server 210 awaits later retrieval by the user of the IHS. One way to gather together software for imaging purposes is described in U.S. Pat. No. 6,298,443 entitled “Method and System for Supplying a Custom Software Image to a Computer System” which was incorporated herein earlier by reference. In one embodiment, the software image is constrained to be downloaded to and operable on only the particular IHS that is requesting a replacement or restored software image. This can prevent use of the software image on unauthorized IHS's.

In some instances it is not necessary to completely reconstruct the software image anew. For instance, some customers request that copies of some software images of their IHS's be stored by the IHS manufacturer. In any event, once the software image is completed, the user's IHS is disconnected from the web site as per block 360. In the course disconnecting from the web site, the user is given instructions on how to retrieve the replacement software image file. For example, the user may be provided with a hyperlink to another web site to gain access to the software image now stored in ODIS imaging server 210. After rebooting the IHS as per block 362, the user follows the hyperlink by clicking on the hyperlink within the IHS's browser. This directs the IHS to a web site which is connected to ODIS imaging server 210. A download of the replacement software image from ODIS imaging server 210 across network 205 to ODIS client 230 now commences as per block 365. When the download is complete, a copy of the software image now resides on IHS 100 on media drive 107 as replacement software image 105. Download server 220 or other server now sends an email to IHS 100 with instructions on how to install the software image that IHS 100 has received as per block 370. Once the user has accessed and retrieved the software image, the software image is deleted from ODIS imaging server 210 as per block 380. The on-demand imaging system process is then terminated at block 330.

It is noted that accessing a boot partition as indicated in diagnostics 245 in FIG. 2 is not the only way to engage a client download manager such as ODIS client download manager 205. Download manager software could also be installed on a floppy disk, CD ROM, DVD or other media which the IHS is capable of accessing. While software download server 220 is referred to as being a remote software download server with respect to customer IHS 100, this terminology is used to indicate simply that there is some distance between download server 230 and IHS 100, although the distance could be very large or very small. It is even possible that remote download software server 230 be located in the same room as customer IHS 100.

Advantageously, the disclosed methodology and apparatus allow a user to restore a software image to an information handling system in a minimal amount of time.

Although illustrative embodiments have been shown and described, a wide range of modification, change and substitution is contemplated in the foregoing disclosure and in some instances, some features of an embodiment may be employed without a corresponding use of other features. Accordingly, it is appropriate that the appended claims be construed broadly and in manner consistent with the scope of the embodiments disclosed herein.

1. A method of returning a customer information handling system (IHS) to a prior software state, the method comprising:
transmitting, by the customer IHS, an image restore request to a remote download software server;
receiving, by the remote download software server, the image restore request;
building, by the remote download software server, a software image in response to the image restore request; and
transmitting, by the remote download software server, the software image to the customer IHS for installation thereon.

2. The method of claim 1 comprising selecting a re-image mode on the customer IHS to initiate the transmitting of the image restore request by the customer IHS to the remote download software server.

3. The method of claim 1 wherein the image restore request includes an IHS identifier associated with the customer IHS.

4. The method of claim 3 wherein the remote download software server stores respective IHS identifiers for previously manufactured IHS's.

5. The method of claim 4 wherein the remote download software server stores software which was used to create a software image on the customer IHS at the time of manufacture.

6. The method of claim 5 including retrieving, by the remote download software server, software corresponding to the unique identifier of the customer IHS.

7. The method of claim 6 including consolidating the software into a software image.

8. The method of claim 7 including activating a download manager on the customer IHS to commence a download of the software image from the remote download software server to the customer IHS.

9. The method of claim 8 including receiving, by the customer IHS, the software image.

10. The method of claim 9 including storing, by the customer IHS, the software image in a media drive on the customer IHS.

11. The method of claim 10 including sending an email message, by the download server, to the customer IHS to instruct the user how to install the software image.

12. The method of claim 11 including deleting the software image from the remote download software server.

13. A software server information handling system (IHS) comprising:
a network port for receiving an image restore request from a customer IHS; and
a download server, coupled to the network port, for storing a plurality of software programs, the download server building a replacement software image for the customer IHS in response to an image restore request received from the customer IHS, the download server communicating the replacement software image to the customer IHS to restore functionality thereto.

14. The software server IHS of claim 13 wherein the replacement software image is unique to the particular customer IHS.

15. The software server IHS of claim 14 including a plurality of imaging mule IHS's, coupled to the download server, wherein software obtained from the download server by a particular one of the imaging mule IHS's is consolidated to form the replacement software image.

16. The software server IHS of claim 13 wherein the plurality of software programs includes an operating system.

17. The software server IHS of claim 13 wherein the plurality of software programs software includes a driver.

18. The software server IHS of claim 13 wherein the plurality of software programs includes an application.

19. The software server IHS of claim 13 wherein the image restore request includes an IHS identifier unique to the particular customer IHS.

20. The software server IHS of claim 15 including an imaging server coupled to the imaging mule IHS's and the network port for storing the replacement software image until it is downloaded by the particular customer IHS requesting the replacement image.

21. The software server IHS of claim 13 wherein a customer IHS is connected to the software server IHS by an Internet connection therebetween.

22. An apparatus for returning a customer information handling system (IHS) to a prior software state, comprising:
means for transmitting, by the customer IHS, an image restore request to a remote download software server;
means for receiving, by the remote download software server, the image restore request;
means for building, by the remote download software server, a software image in response to the image restore request; and
means for transmitting, by the remote download software server, the software image to the customer IHS for installation thereon.
